(19) United States
(12) Patent Application Publication
(10) Pub. No.: US 2008/0049162 A1
(43) Pub. Date: Feb. 28, 2008

(54) FIXING STRUCTURE AND ASSEMBLY METHOD THEREOF

(75) Inventors: Chang-Ho Shen, Hsinchu (TW); Hui-Kai Chou, Hsinchu (TW); Kuang-Chou Lai, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/838,269

(22) Filed: Aug. 14, 2007

(30) Foreign Application Priority Data
Aug. 25, 2006 (TW) 95131331

(51) Int. Cl. G02F 1/13; G02F 1/1339

(52) U.S. Cl. 349/58; 349/192

(57) ABSTRACT

A fixing structure fixes a liquid crystal panel. The liquid crystal panel is disposed on a backlight module, comprising at least one seal element disposed on edges of the liquid crystal panel, comprising a first transparent substrate, a second transparent substrate, an active circuit array, a liquid crystal layer, and seal elements. The active circuit array, the liquid crystal layer and the seal elements are disposed between the first transparent substrate and the second transparent substrate. The second transparent substrate corresponds to the backlight module. The fixing structure comprises a frame and elastic elements. The elastic elements are adhered to a lower surface of the frame. The elastic elements are sandwiched between the frame and the first transparent substrate. The elastic elements contact the first transparent substrate in positions above the seal elements.

### BACKGROUND OF THE INVENTION

1. Field of the Invention

The invention relates to a fixing structure for a liquid crystal panel, and in particular to a fixing structure preventing liquid crystal panel warping.

2. Description of the Related Art

FIG. 1a shows a conventional display 1 comprising a liquid crystal panel 10, a fixing structure 20, a pair of supporting frames 30, an optical sheet 40, and a backlight module 50. FIG. 1b is a sectional view of an assembled display 1, wherein the optical sheet 40 is disposed above the backlight module 50, and the supporting frames 30 are disposed above the optical sheet 40 and the backlight module 50. The liquid crystal panel 10 is disposed above the supporting frames 30. The fixing structure 20 covers and fixes liquid crystal panel 10.

In the conventional display 1, the fixing structure 20 protects the liquid crystal panel 10, preventing warping by gravity. FIG. 1c is an enlarged view of portion A of FIG. 1b, wherein the liquid crystal panel 10 comprises a first transparent substrate 11, a second transparent substrate 12, an active circuit array 13, a liquid crystal layer 14, and seal elements 15. The active circuit array 13, the liquid crystal layer 14 and the seal elements 15 are disposed between the first transparent substrate 11 and the second transparent substrate 12. The second transparent substrate 12 corresponds to the backlight module 50. The fixing structure 20 comprises a frame 22 and elastic elements 21. The elastic elements 21 are adhered to a lower surface of the frame 22. Conventionally, the elastic elements 21 are adhered along an inner edge 23 of the frame 22 and align therewith. However, the elastic elements 21 contact the first transparent substrate 11 in positions above the liquid crystal layer 14. Thus, a cell gap between the first transparent substrate 11 and the second transparent substrate 12 changes, and light leak occurs in dark image display.

### BRIEF SUMMARY OF THE INVENTION

A detailed description is given in the following embodiments with reference to the accompanying drawings.

The invention provides a fixing structure for a liquid crystal panel. The liquid crystal panel is disposed on a backlight module, comprising at least one seal element disposed on edges of the liquid crystal panel, comprising a first transparent substrate, a second transparent substrate, an active circuit array, a liquid crystal layer, and seal elements. The active circuit array, the liquid crystal layer and the seal elements are disposed between the first transparent substrate and the second transparent substrate. The second transparent substrate corresponds to the backlight module. The fixing structure comprises a frame and elastic elements. The elastic elements are adhered to a lower surface of the frame. The elastic elements are sandwiched between the frame and the first transparent substrate. The elastic elements contact the first transparent substrate in positions above the seal elements.

In the embodiment, contact positions of the elastic elements and the first transparent substrate are above the seal elements. The seal elements support the fixing structure, preventing the fixing structure from pressing the liquid crystal layer, and maintain a cell gap between the first transparent substrate and the second transparent substrate. In the embodiment, the fixing structure prevents the liquid crystal panel from warping by gravity, and the seal elements support the fixing structure preventing light leak in dark image display.

### BRIEF DESCRIPTION OF THE DRAWINGS

The invention can be more fully understood by reading the subsequent detailed description and examples with references made to the accompanying drawings, wherein:

FIG. 1a shows a conventional display;

FIG. 1b is a sectional view of an assembled display;

FIG. 1c is an enlarged view of portion A of FIG. 1b;

FIG. 2 shows a display of an embodiment of the invention;

FIG. 3 is a partial sectional view of a display of an embodiment of the invention;

FIG. 4 is an enlarged view of portion B of FIG. 3;

FIG. 5 is a bottom view of a fixing structure of an embodiment of the invention; and

FIG. 6 shows a modified embodiment of the invention.

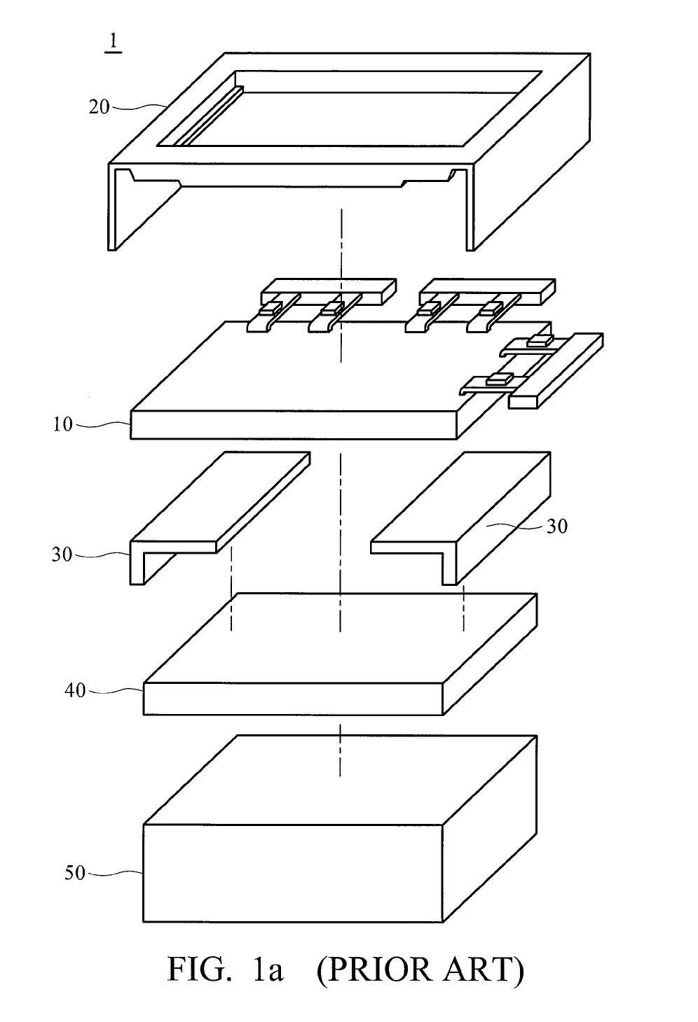

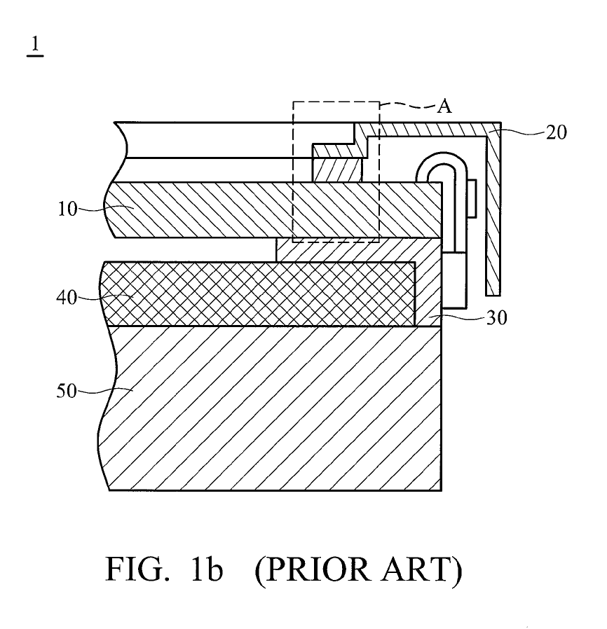

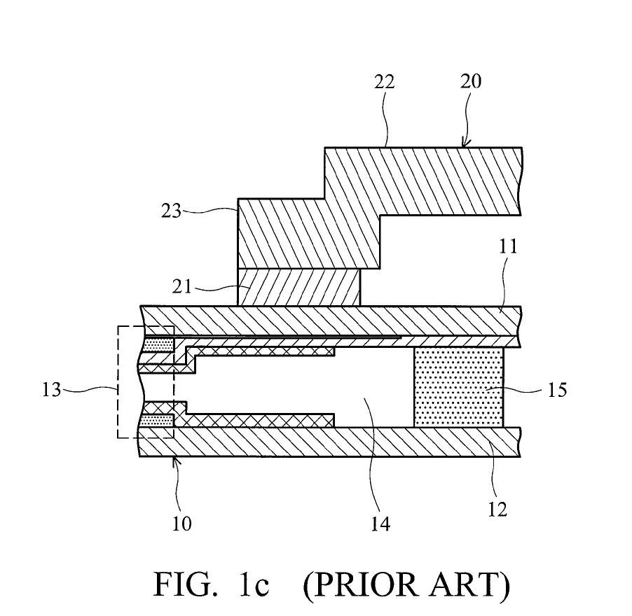

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by the appended claims.

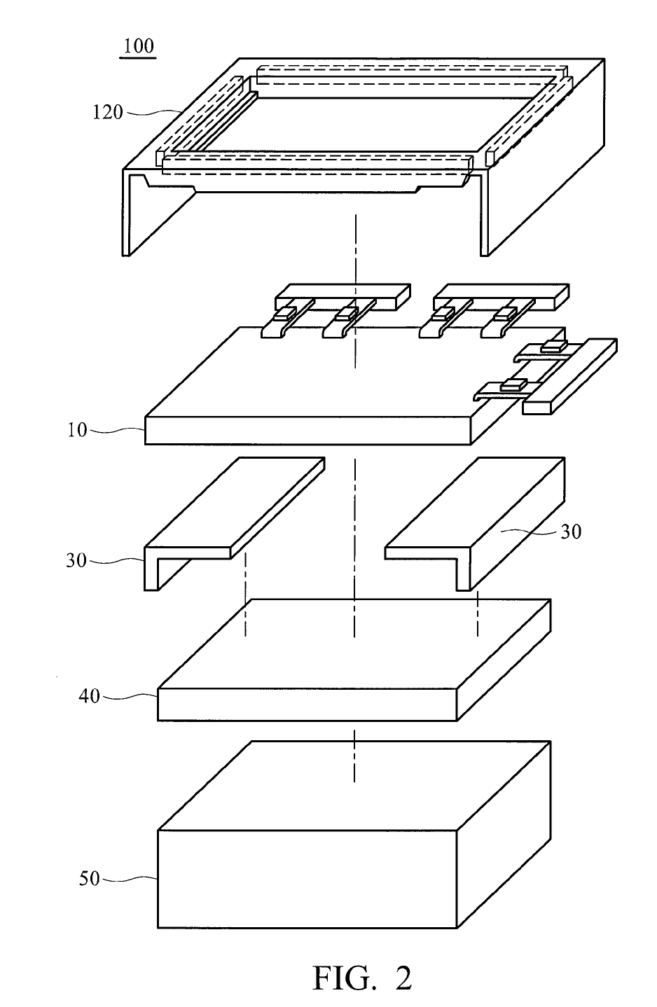

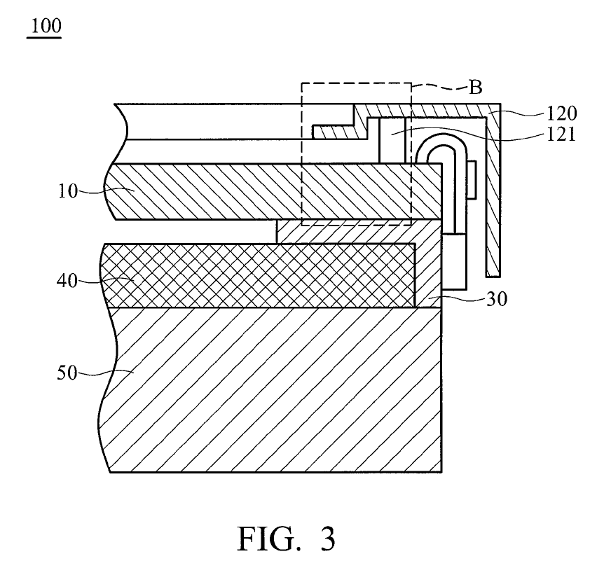

FIG. 2 shows a display 100 of an embodiment, comprising a liquid crystal panel 10, a fixing structure 120, supporting frames 30, an optical sheet 40 and a backlight module 50. FIG. 3 is a partial sectional view of display 100, wherein the optical sheet 40 is disposed on the backlight module 50, the supporting frames 30 are disposed above the optical sheet 40 and the backlight module 50, the liquid crystal panel 10 is disposed on the supporting frames 30, and the fixing structure 120 presses and fixes the liquid crystal panel 10. The fixing structure 120 comprises an elastic element 121.

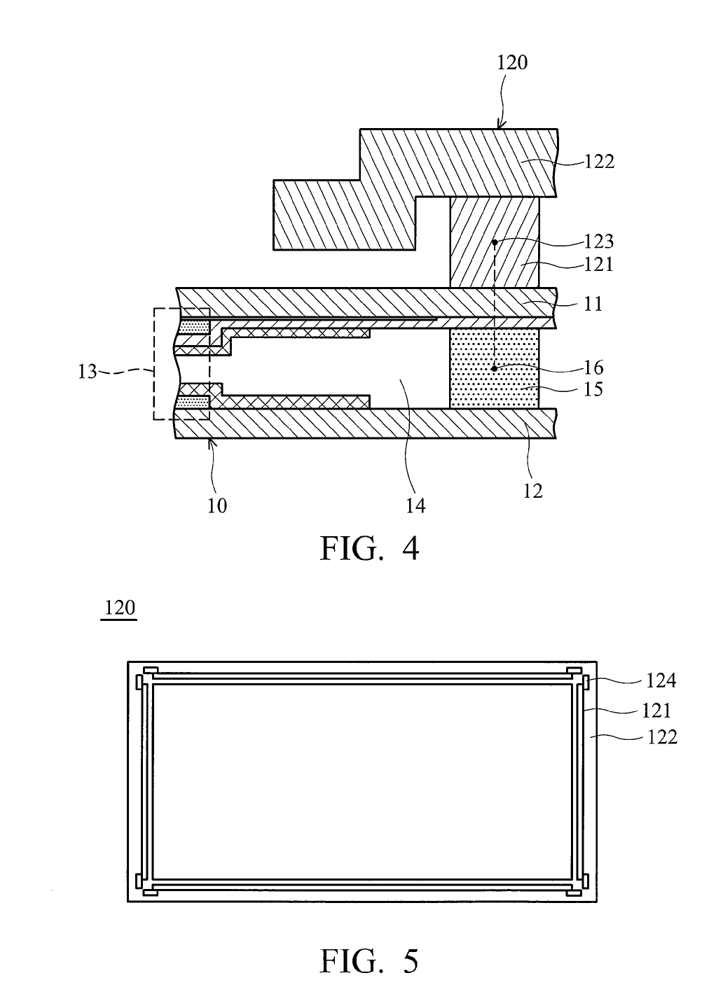

FIG. 4 is an enlarged view of portion B of FIG. 3. The liquid crystal panel 10 comprises a first transparent substrate 11, a second transparent substrate 12, an active circuit array 13, a liquid crystal layer 14, and seal elements 15. The active circuit array 13, the liquid crystal layer 14 and the seal elements 15 are disposed between the first transparent substrate 11 and the second transparent substrate 12. The second transparent substrate 12 corresponds to the backlight module 50. The fixing structure 20 comprises a frame 122 and the elastic element 121. The elastic element 121 is adhered to a lower surface of the frame 122. As shown, the elastic element 121 is sandwiched between the frame 122 and the first transparent substrate 11. The elastic element 121 contacts the first transparent substrate 11 above the seal elements 15.

Preferably, the elastic element 121 is made of rubber or plastic.

In FIG. 4, a first center 123 of a first cross-section of the elastic element 121 and a second center 16 of a second cross-section the seal element 15 are located on a same vertical line, and the first cross-section and the second cross-section are on a same vertical plane.

In the embodiment, contact positions of the elastic element 121 and the first transparent substrate 11 are above the seal elements 15. The seal elements 15 support the fixing structure 120, preventing the fixing structure 120 from pressing the liquid crystal layer 14, and maintain a cell gap between the first transparent substrate 11 and the second transparent substrate 12. In the embodiment, the fixing structure 120 prevents the liquid crystal panel 10 from warping by gravity, and the seal elements 15 support the fixing structure 120 preventing light leak in dark image display.

FIG. 5 is a bottom view of the fixing structure 120, wherein the longitudinal elastic elements 121 are adhered to the lower surface of the frame 122 and are preferably made of rubber or plastic. Mark portions 124 are formed on the lower surface of the frame 122, and the elastic elements 121 are adhered therealong. During assembly of display 100, liquid crystal panel 10, fixing structure 120, supporting frames 30, optical sheet 40 and backlight module 50 are assembled. Fixing structure 120 is assembled to the liquid crystal panel 10, wherein the contact positions of the elastic elements 121 and the liquid crystal panel 10 are above the seal elements 15 thereof.

In an embodiment of the present invention, the mark portion 124 is a linear mark overlapping a side of the seal element 15 facing the center of the liquid crystal panel 10, and a side of the elastic element 121 facing the center of the liquid crystal panel overlaps the linear mark.

In an embodiment of the present invention, each mark portion 124 is a groove overlapping the seal element 15, and a side of the elastic element 121 wedges the groove and another side thereof contacting the liquid crystal panel 10.

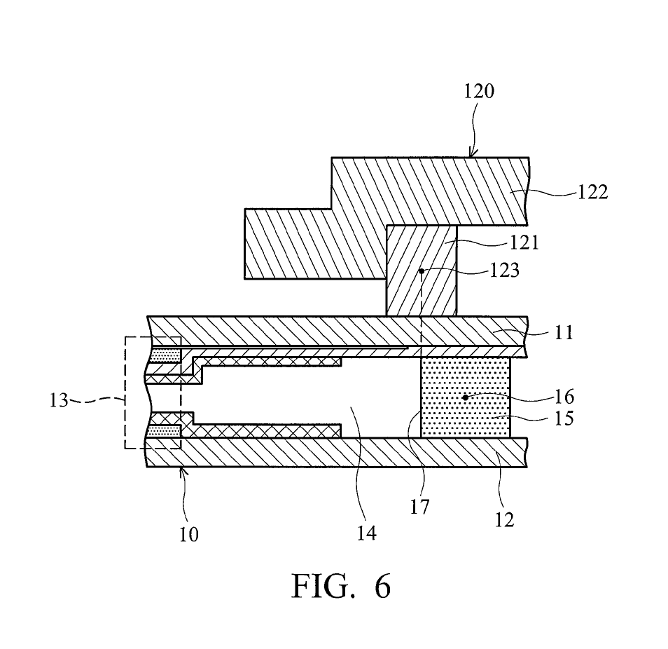

FIG. 6 shows a modified embodiment of the present invention, wherein each seal element 15 comprises an inner side 17 contacting the liquid crystal layer 14. The first center 123 of the first cross-section of the elastic element 121 is located above the inner side 17. In other words, the first center of the first cross-section (i.e., vertical cross-section) of the elastic element is located above a side of the seal element facing the liquid crystal panel.

In the embodiment, the first center 123 of the first cross-section of the elastic element 121 can be located above positions between the inner side 17 and the second center 16.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fixing structure for fixing a liquid crystal panel comprising at least one seal element disposed on edges of the liquid crystal panel, comprising:
a frame covering the edges of the liquid crystal panel; and
at least one elastic element sandwiched between the frame and the liquid crystal panel, wherein a contact position of the elastic element and the liquid crystal panel is above the seal element.

2. The fixing structure as claimed in claim 1, wherein a first center of a first cross-section of the elastic element and a second center of a second cross-section the seal element are located on a same vertical line, and the first cross-section and the second cross-section are on a same vertical plane.

3. The fixing structure as claimed in claim 1, wherein a first center of a first cross-section of the elastic element is located above a side of the seal element facing a center of the liquid crystal panel.

4. The fixing structure as claimed in claim 1, wherein the frame comprises a mark portion formed on a surface of the frame facing the liquid crystal panel, with the mark portion substantially corresponding to the seal element.

5. The fixing structure as claimed in claim 4, wherein the mark portion is a linear mark overlapping a side of the seal element facing a center of the liquid crystal panel, and a side of the elastic element facing the center of the liquid crystal panel overlaps the linear mark.

6. The fixing structure as claimed in claim 4, wherein the mark portion is a groove overlapping the seal element, and a side of the elastic element wedges the groove and another side thereof contacting the liquid crystal panel.

7. The fixing structure as claimed in claim 1, wherein the elastic element is made of rubber or plastic.

8. An method for assembling a liquid crystal display, comprising:
providing a backlight module, a liquid crystal panel and a fixing structure, the fixing structure comprising at least one elastic element, and the liquid crystal panel comprising a seal element disposed on edges thereof;
combining the backlight module and the liquid crystal panel; and
combining the fixing structure and the liquid crystal panel, wherein a contact position of the elastic element and the liquid crystal panel is above the seal element.

9. The method as claimed in claim 8, further comprising attaching the elastic element on the frame, wherein the frame comprises a mark portion formed on a surface of the frame facing the liquid crystal panel, and the seal element is attached along the mark portion.
